(19) United States
(12) Patent Application Publication
(10) Pub. No.: US 2023/0234051 A1
(43) Pub. Date: Jul. 27, 2023

(54) MICROFLUIDIC DEVICE AND METHOD

(71) Applicant: THE RESEARCH FOUNDATION FOR THE STATE UNIVERSITY OF NEW YORK, Albany, NY (US)

(72) Inventors: Eric BROUZES, Port Jefferson, NY (US); Martin SAUZADE, Setauket, NY (US)

(73) Assignee: THE RESEARCH FOUNDATION FOR THE STATE UNIVERSITY OF NEW YORK, Albany, NY (US)

(21) Appl. No.: 18/008,590

(22) PCT Filed: Jun. 11, 2021
(86) PCT No.: PCT/US2021/036947

§ 371 Date: Dec. 6, 2022

Related U.S. Application Data
(60) Provisional application No. 63/038,053, filed on Jun. 11, 2020.

(51) Int. Cl. B01L 3/00

(52) U.S. Cl. CPC B01L 3/502715; B01L 2300/0861; B01L 2300/0838; B01L 2400/0406; B01L 2300/12

(57) ABSTRACT

A microfluidic device is disclosed which comprises a main flow channel and a partition chamber connected to a portion of same by a chamber inlet and chamber outlet. The device utilizes select cross sections to advantage capillary effects during filling and partitioning steps to isolate biological or other samples in the partition chamber for analysis and can be employed in a digital array.

### CROSS REFERENCE TO RELATED APPLICATION

This application claims priority under 35 U.S.C. § 119 to provisional patent application U.S. Ser. No. 63/038,053, filed Jun. 11, 2020, the entire contents of which are incorporated herein by reference for any purpose.

### GOVERNMENT STATEMENT OF SUPPORT

This invention was made with government support under CA 181595 awarded by the National Institutes of Health. The government has certain rights in the invention.

### FIELD

The disclosure pertains to a microfluidic device, a digital array employing same, and a method for analyzing biological samples such as cells, viruses, proteins, nucleic acids, and the like.

### BACKGROUND

Digital assays represent a class of assays designed to simplify quantification of molecules by dividing the samples into sub-volumes or partitions such that each partition contains very few or one molecule of interest or none. An amplification scheme, e.g. polymerase chain reaction (PCR), is then used to reveal which partition contains a target molecule. The proportion of empty and filled partitions is used to back-calculate the initial concentration of the molecules in the sample using Poisson's statistics. The concentration range depends directly on the volume of the partitions, and some strategies using a range of different volumes in a single assay has been demonstrated to increase the dynamic range of the assay.

Several technologies have been developed to generate partitions that rely on microfluidic droplet technology, arrays of microwells, or chambers, made of polydimethylsiloxane (PDMS) using self-partitioning strategies. These approaches differ in materials and instruments required to generate and read out the proportion of empty and filled partitions. Droplet-based approaches require oil and surfactant and a microfluidic device to generate the partitions. Various examples of these approaches include those commercially known as Quanta-Life, Rain Dance Technologies, Bio-Rad and Stella.

The PCR amplification step is typically performed in an emulsion format in a conventional microtube and the droplets are re-injected and their fluorescence is interrogated with a laser in a single-tile format. Some approaches have also shown the possibility of reading droplets in 2D format to increase throughput. In general, droplet-based systems require significant equipment and manipulation to generate droplets and read out the signal. In this regard, a simplified droplet generation step has been designed by developing a small insert used on a regular microtube to generate droplets, the actuation being provided by a centrifuge, as opposed to syringe pumps or pressure controllers. This technology has been commercially known as Clarity. In general, droplet-based strategies have limited dynamic range because the droplet size is fixed by the dimensions of the nozzle device.

Another approach relating to microwells for digital PCR has been commercially known by Life Technologies. In this approach, an array of microwells is first filled with the sample, and a layer of oil is then flowed on top to isolate the microwells from each other and create partitions. Other approaches have developed an enclosed device comprising chambers connected to filling channels to create partitions. These static approaches have the advantages to be compatible with fluorescent scanners, a developed and proven technology. The main hurdle of those strategies is the difficulty in filling the chambers or microwells in the first place. In these approaches, technical and complex protocols need to be used to efficiently perform the filling step either in the microwell array or chamber format. For example, an array of microwells can be pre-filled with CO₂ gas or sugar to help filling, and the chamber format relies on the gas porosity of PDMS. Using PDMS is limiting for commercial applications because of the high cost associated with manufacturing devices in this material. Thus there is a continuing need for improved an improved microfluidic device that can be used in a digital array.

### SUMMARY

The present disclosure relates in one aspect to a microfluidic device comprising a main flow channel; and a partitioning chamber connected to a section of the main flow channel by a chamber inlet and a chamber outlet, the chamber inlet comprising a chamber inlet cross section, the chamber outlet comprising one or more outlet capillary channels, wherein a portion of the main flow channel between the chamber inlet and the chamber outlet comprises a cross section (i) less than the chamber inlet cross section, and (ii) greater than the cross section of each individual outlet capillary channel. In one embodiment, the material of construction for the microfluidic device comprises a thermoplastic that is non-permeable to gas, e.g. air, such as a Cyclic Olefin Copolymer (COC).

In another practice, the disclosure is directed to a method of filling a biological sample into a microfluidic device for analysis, the method comprising (a) providing a microfluidic device comprising a main flow channel; and a partitioning chamber connected to a section of the main flow channel by a chamber inlet and a chamber outlet, the chamber inlet comprising a chamber inlet cross section, the chamber outlet comprising one or more outlet capillary channels, wherein a portion of the main flow channel between the chamber inlet and the chamber outlet comprises a cross section (i) less than the chamber inlet cross section, and (ii) greater than the cross section of each individual outlet capillary channel; (b) providing a flow of a fluid comprising a biological sample in the main flow channel under conditions effective to divert a portion of the fluid from the main flow channel to the partitioning chamber and the chamber outlet; (c) ceasing the flow of the fluid comprising the biological sample; and (d) providing a flow of an immiscible fluid in the main flow channel under conditions effective to flow the immiscible fluid through the main channel and not into the chamber inlet or the chamber outlet to seal off the partitioning chamber and any fluid comprising the biological sample contained therein. Representative biological material include without limitation a cell, a virus, a protein, a nucleic acid, portions of any of the foregoing, and the like.

In another practice, the disclosure is directed to a method of analyzing a biological sample comprising filling a microfluidic device with a biological sample as aforesaid using steps (a), (b), (c), followed by step (d) performing an analysis on the biological sample contained in the partitioning chamber, wherein the analysis is quantitative, qualitative, or both. In one practice, the analysis comprises performing a molecular reaction on the biological sample, e.g. an amplification reaction, a detection reaction, or both, including without limitation, any one or more of the following: a polymerase chain reaction (PCR), isothermal amplification, a LAMP assay, fluorescence detection, and luminescence detection.

### BRIEF DESCRIPTION OF THE DRAWINGS

FIG. 1A depicts an embodiment of the microfluidic device of the disclosure. FIGS. 1B and 1C respectively depict an embodiment of the method of filling the device of FIG. 1A and sealing off the partition chamber.

FIG. 2 depicts an embodiment of the microfluidic device of the disclosure. FIG. 2B depicts an embodiment of the method of filing FIG. 2A; FIGS. 2C and 2D respectively depict other embodiments of the method of sealing off the partition chamber.

FIG. 3 depicts an embodiment of the microfluidic device of the disclosure and arranged in series flow.

FIG. 4 depicts an embodiment of the microfluidic device of the disclosure and arranged in series flow.

FIGS. 5A and 5B respectively depict other embodiments of the microfluidic device of the disclosure and arranged in series flow.

FIG. 6 is a graph showing the differential in Laplace pressure (proportional factor without interfacial energy).

### DETAILED DESCRIPTION

The following detailed description of embodiments of the invention will be made in reference to the accompanying Figures. In describing representative embodiments of the disclosure, explanation about related functions or constructions known in the art are omitted for the sake of brevity and to avoid obscuring the invention with unnecessary detail. The contents of all articles cited herein are incorporated by reference in their entirety for any purpose.

The design of the microfluidic device described herein enables a method wherein the device self-partitions biological or other samples into a partition chamber wherein the sample can be isolated and analyzed. The device utilizes capillary effects attributable to the size and cross sectional differences in a main flow channel and of inlets and outlets to the partitioning chamber which act as capillary valves whereby fluid flow is guided to desired directions using select flow regimes of high and low capillary number (Ca) and depending upon the nature of the fluid during the steps of loading and partitioning.: In one practice, an air-aqueous phase is employed in the filling step, and aqueous and oil phases are employed in the portioning step.

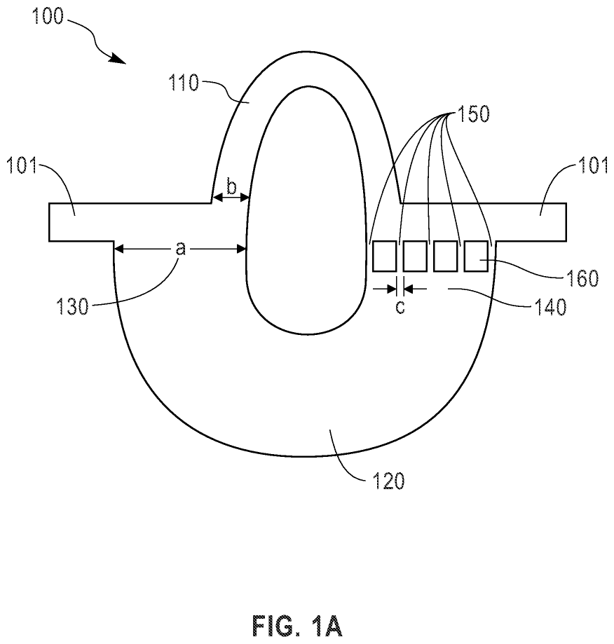

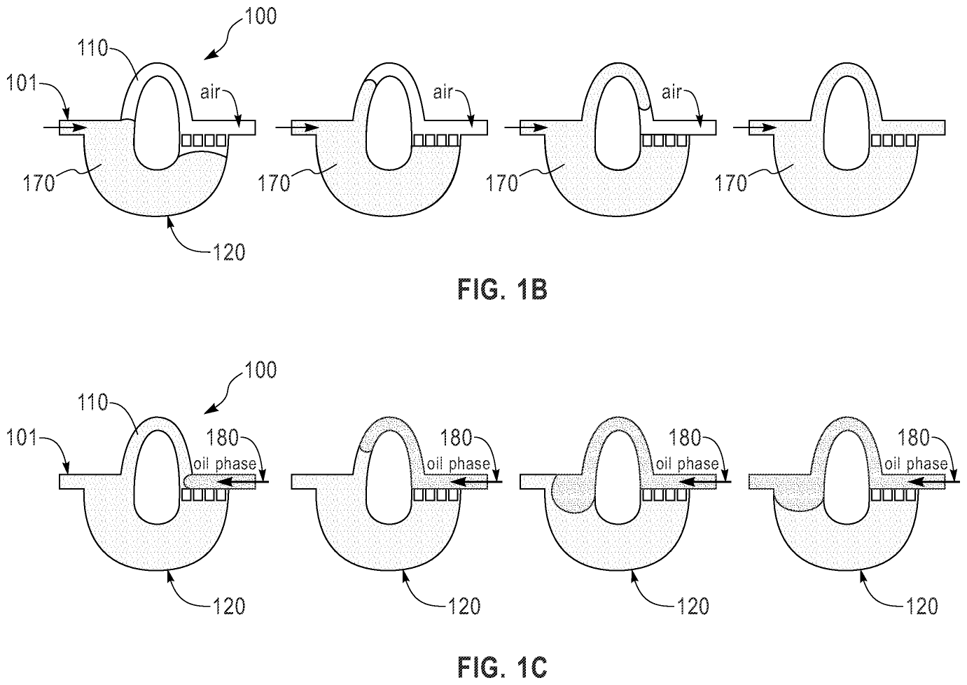

Referring to FIGS. 1A, 1B, and 1C, thereat is top down view of an embodiment of a microfluidic device 100 of disclosure comprising a microfluidic main flow channel 101 and a partitioning chamber 120 which is connected to a section of the main flow channel 101 by a chamber inlet 130 and a chamber outlet 140. Chamber outlet 140 comprises one or more outlet capillary channels 150. In the practice shown, outlet capillary channels 150 are preferably parallel to each other but need not be and are formed by elements 160 which protrude vertically (or alternatively protrude horizontally) into chamber outlet 140. FIG. 1 depicts a practice of the device having five outlet capillary channels 150, three of which are formed between the four square elements or posts 160 (elements 160 can be of any suitable shape, including square or rectangular; as used herein the term rectangular subsumes square) and two of which are formed between the walls of chamber outlet 140 and elements 160 adjacent same. As shown, the portion 110 of the main flow channel between chamber inlet 130 and chamber outlet 140 comprises a cross section (“b”) that is less than the cross section of the chamber inlet (“a”) and greater than the cross section (“c”) of the each individual outlet capillary channel. The outer capillary channels 150 can each individually have the same or different cross section. As depicted in FIG. 1, portion 110 has a cross section constant across its entire length; alternatively, portion 110 (depicted as a loop although other configurations can be employed, e.g. portion 110 can be linear) can be comprise a cross section that varies along its length either discretely or by taper, e.g. one or more segments of differing cross section including discrete segments and tapering cross sections. It will be understood that the cross sectional sizes herein can vary subject to them providing the capillary effects disclosed.

In one non-limiting practice for the device embodiments disclosed herein, the chamber inlet comprises a cross section “a” of between 50 μm and 250 μm; the one or more capillary channels each independently comprise a cross section “c” of between 7.5 μm and 20 μm; and the cross section “b” of the portion of the main flow channel between the chamber inlet and the chamber is between 15 μm and 30 μm. The foregoing practices include each and every value in the ranges stated, e.g. the range of between 50 μm and 250 μm includes 51 μm, 52 μm, 53 μm, etc and 247 μm, 248 μm, 249 μm, etc. and includes all permutations of intermediate ranges, e.g. between 51 μm and 250 μm, 51 μm and 249 μm, 52 μm and 249 μm, 50 μm and 249 μm, 50 μm and 248 μm etc.

In one practice, the microfluidic device of the disclosure can be made of materials know in the art for digital arrays, including polymers such as PDMS. Preferably, the microfluidic device comprises a material of construction that is non-permeable to gas, e.g. non-permeant to air, such as without limitation glass, thermoplastics and the like. A non-limiting example of a suitable thermoplastic is Cyclo Olefin Copolymer (COC, commercially available as Topas 5013L-10, T_{g}=134° C.). In circumstances where the device comprises a material non-permeable to gas, the partitioning chamber is fully filled with the aqueous phase without relying on gas porosity of the device material.

FIG. 1B shows in four frames an embodiment of a filling step of the device of FIG. 1A. In the practice shown, during the filling step, an aqueous phase 170 (shown as darkened area), which aqueous phase can contain a biological sample, is flowed into main channel 101 (the flow depicted by the arrow from the left side, i.e. the direction of flow in the main flow channel is from the chamber inlet to the chamber outlet) and preferentially flows into the partitioning chamber 120 due to larger cross-section of chamber inlet 130 as opposed to the smaller cross section of portion 110. The larger cross section of 130 accordingly offers lower capillary resistance, as against the capillary resistance offered by 110, until the flow reaches the outlet capillary channels 150 (formed by the series of posts 160) at chamber outlet 140 which creates a large resistance to the flow from partitioning chamber 120. At this point, the flow of the aqueous phase is diverted towards portion 110 which has a smaller cross-section than chamber inlet 130, but a larger cross section than cross section of the outer capillary channels 150 created by the series of posts 160. As a result, the partitioning chamber 120 is fully filled with the aqueous phase. Air that may have been trapped in the device is forced out ahead of the aqueous phase. In circumstances where the device comprises a material non-permeable to gas, the partitioning chamber is fully filled with the aqueous phase without relying on gas porosity of the device material. In one practice, the filling step for the aqueous phase wherein the flow in the main flow channel is in the direction of the chamber inlet to the chamber outlet, the flow is under conditions effective wherein the capillary force associated with the flow is greater than the viscous force associated with the flow.

FIG. 1C shows in four frames an embodiment of a partitioning step for the device of FIG. 1A as filled as in FIG. 1B. In the practice shown, partitioning is performed by flowing an immiscible fluid phase, e.g. an oil 180 (shown in the area with diagonal lines), from the opposite side of which the aqueous phase was flowed (immiscible fluid is flowed from the right side as indicated by the arrow for 180, i.e. the direction of flow in the main flow channel is from the chamber outlet to the chamber inlet). The series of posts 160 and the capillary channels created thereby prevents the oil phase from entering the partition chamber 120 and displacement of the aqueous phase (which can contain a biological sample) already contained therein. Instead, because of the attendant capillary effects, the oil flows through the portion 110 channel and seals off the partitioning chamber 120 to isolate the aqueous phase therein for subsequent analysis. Non-limiting examples of immiscible fluids include those that comprise an immiscible oil, e.g. mineral oil; preferably the immiscible oil is fluorinated, and preferably comprises a surfactant.

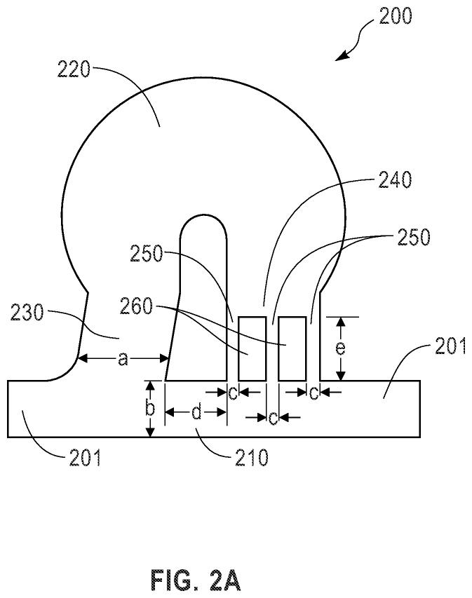

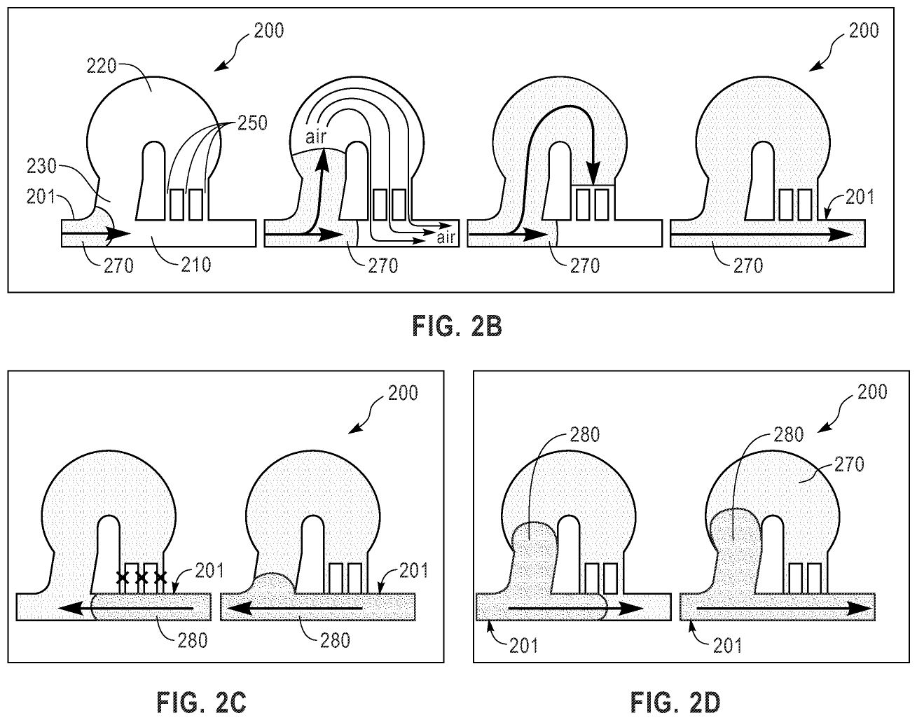

Referring to FIGS. 2A, 2B, and 2C, thereat is top down view of another embodiment of a microfluidic device 200 of the disclosure. Device 200 comprises a main flow channel 201 and a partitioning chamber 220 which is connected to a section 210 (shown as having distance “d”) of the main flow channel 201 by chamber inlet 230 and chamber outlet 240. Chamber outlet 240 comprises one or more outlet capillary channels 250 formed by elements 260 (shown as vertical rectangular parallel posts). The embodiment of FIG. 2 shows three, preferably parallel, capillary channels 250: one between elements 260 and two between the walls of the chamber outlet and the respective adjacent element 260. Representative dimensions in the device of FIG. 2A are as follows: cross section “a” is 100 μm; cross section “b” is 60 μm; each of cross sections “c” is 10 μm; distance “d” is 67 μm; distance “e” for each of elements 260 is 70 μm.

FIG. 2B shows in four frames an embodiment of a filling step for the device of FIG. 2A. In the practice shown, during the filling step, an aqueous phase 270 (shown as darkened area), which aqueous phase can contain a biological sample, is flowed into main channel 201 (the flow of aqueous phase depicted by the arrow from the left side, i.e. the direction of flow in the main flow channel is from the chamber inlet to the chamber outlet) and preferentially flows into the partitioning chamber 220 due to larger cross-section of chamber inlet 230 as opposed to the smaller cross section of portion 210. The larger cross section of 230 accordingly offers lower capillary resistance, as against the capillary resistance offered by 210, until the flow reaches the outlet capillary channels 250 (formed by the series of posts 260) at chamber outlet 240 which creates a large resistance to the flow from partitioning chamber 220. At this point, the flow of the aqueous phase is diverted towards portion 210 which has a smaller cross-section than chamber inlet 130, but a larger cross section than cross section of the capillary channels 250 created by the series of posts 160. As a result, the partitioning chamber 220 is fully filled with the aqueous phase. Air that may have been trapped in the device is forced out ahead of the aqueous phase.

FIG. 2C shows in two frames an embodiment of a partitioning step for the device of FIG. 2A as filled in FIG. 2B. In the practice shown in FIG. 2C, partitioning is performed by flowing an immiscible fluid phase, e.g. an oil 280 (the oil phase shown by the area with diagonal lines), from the opposite side from which the aqueous phase was flowed (flow of the immiscible fluid is from the right side as indicated by the arrow for 280, i.e. the direction of flow in the main flow channel is from the chamber outlet to the chamber inlet). The series of posts 260 and the capillary channels created thereby prevents the oil phase from entering the partition chamber 220 (the prevention of flow indicated by the Xs) and displacement of the aqueous phase (which can contain a biological sample) already contained therein. Instead, because of the attendant capillary effects, the oil flows through the portion 210 channel and seals off the partitioning chamber 220 to isolate the aqueous phase therein for subsequent analysis.

FIG. 2D shows in two frames an alternative embodiment of a partitioning step for the device of FIG. 2A as filled in FIG. 2B. In the practice shown in FIG. 2D, partitioning is performed by flowing an immiscible fluid phase as in FIG. 2C, only the oil phase (oil phase shown by the area with diagonal lines) is from the same side in the aqueous phase was flowed (flow of the immiscible fluid is from the left side as indicated by the arrow for 280, i.e. the direction of flow in the main flow channel is from the chamber inlet to the chamber outlet). The series of posts 260 and the capillary channels created thereby slows down the entering of the oil phase into the partition chamber 220 and displacement of the aqueous phase (which can contain a biological sample) already contained therein due to the higher hydrodynamic resistance than the main channel. Instead, because of the relative hydrodynamic resistance, the oil flows through the portion 210 channel and seals off the partitioning chamber 220 to isolate the aqueous phase therein for subsequent analysis.

For the filling step: preferably, the filling step for the aqueous phase wherein the flow in the main flow channel is in the direction of the chamber inlet to the chamber outlet, the flow is under conditions effective wherein the capillary force associated with the flow is greater than the viscous force associated with the flow of aqueous phase.

For the partitioning step: (i) the partitioning step for the immiscible fluid phase wherein the flow in the main flow channel is in the direction of the chamber inlet to the chamber outlet, the flow is under conditions effective wherein the capillary force associated with the flow is lower than the viscous force associated with the flow of immiscible fluid; (ii) the partitioning step for the immiscible fluid phase wherein the flow in the main flow channel is in the direction of the chamber outlet to the chamber inlet, the flow is under conditions effective wherein the viscous force associated with the flow is lower than the capillary force associated with the flow of immiscible fluid. In one practice, Capillary Number (Ca) is used. Capillary Number as known in the art is a dimensionless quantity that relates viscous forces in a system to the surface tension forces, and can be used where forces resulting from fluid motion (e.g. viscous forces) are to be compared to forces resulting from surface tension (e.g. capillary forces). Higher Ca is generally controlled by higher flow rate. In one practice, the filling step with aqueous phase is under conditions of low Ca, e.g. Ca is less than 1. In another practice, the partitioning step (i) above is a high Ca, e.g. Ca greater than 1 in order for the viscous effects to overcome capillary effects and enable the immiscible fluid to continue through the main flow channel which under the circumstances has lower hydrodynamic resistance. In another practice, the partitioning step (ii) above is at low Ca, e.g. Ca is less than 1 in order for the capillary effects to prevent flow from going through the capillary channels.

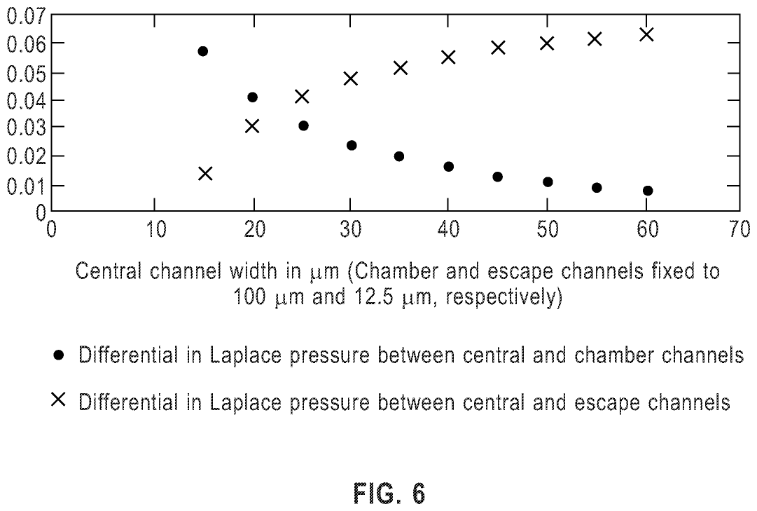

FIG. 6 is a graph of the differential in Laplace pressure based on the different widths (cross sections) of the main flow channel, chamber inlet, and capillary channels at the chamber outlet. By calculation, the graph in FIG. 6 reports the differential in:

$$( \frac{1}{{R}_{1}} + \frac{1}{{R}_{2}} )$$

of the Laplace pressure:

$$Δ P = σ \cdot ( \frac{1}{{R}_{1}} + \frac{1}{{R}_{2}} )$$

As can be seen, the curve denoted with X represents the differential in Laplace pressure between the main flow channel and the capillary channels at the chamber outlet. The curve represented by dots represents the differential in Laplace pressure between the main flow channel and the chamber inlet. Preferred widths are located where the two curves tend to converge.

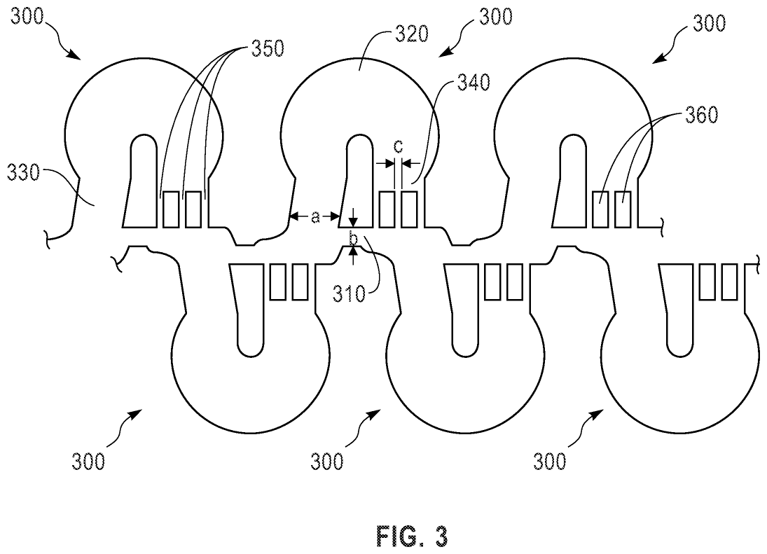

FIG. 3 depicts another embodiment of the microfluidic device 300 of the disclosure. Multiple devices 300 are depicted as arranged in series. Each device 300 comprises partition chamber 320 and three capillary channels 350 at chamber outlet 340 formed by elements 360. In the practice shown and based upon FIG. 6, each capillary channel has a cross section (“c”) of 12.5 μm; each chamber inlet 330 has a cross section (“a”) of 100 μm; and the cross section of portion 310 of the main flow channel has a cross section (b”) of 22.5 μm. As can be ascertained from FIG. 6, the portion 310 having a cross section of 22.5 μm channel and the chamber inlet of 100 μm can each have different cross sections if the differential in Laplace pressure is sufficient to obtain capillary effects for both.

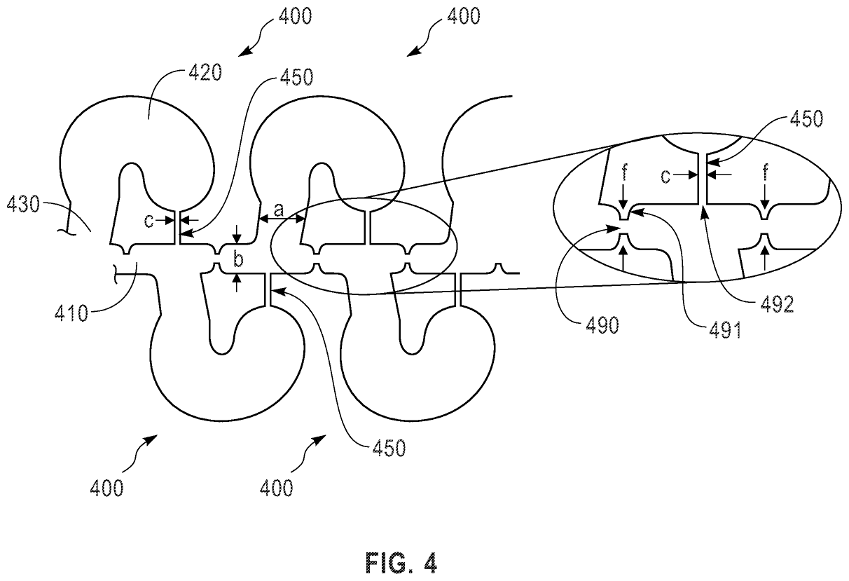

FIG. 4 depicts another embodiment of the microfluidic device 400 of the disclosure having a single capillary channel at the outlet chamber. Multiple devices 400 are depicted as arranged in series. Each device 400 comprises partition chamber 420 and each outlet chamber comprises one capillary channel 450; in the practice shown, capillary channel is configured as an elongated neck. In the practice shown and based upon FIG. 6, each outlet chamber capillary channel 450 has a cross section (“c”) of 12.5 μm; and each chamber inlet 430 has a cross section (“a”) of 100 μm. In the practice shown, the portion 410 of the main flow channel comprises two segments each of which have a cross section “b” of 60 μm and connected by a neck down capillary channel 490 to further restrict the width of the main flow channel; the neck down capillary channel 490 and having cross section “f” which in the practice illustrated “f” is 20 μm. In the practice shown, the outlet capillary channel 450 is connected to portion 410 at point 492 which is between adjacent neck down capillary channels 490. The transition from neck down capillary channel 490 to portion 410 is indicated by 491.

The embodiments shown in FIGS. 3 and 4 illustrate the following: 1) they assure enough differential in Laplace pressure as shown in FIG. 6 between the inlet chamber and the main flow channel, and between the main flow channel and the capillary channel(s) at the outlet chamber; 2) that there can be any number of capillary channels at the outlet chamber; and 3) that the restrictive width of the main channel can be achieved at a short neckdown (identified as 413 having cross section “f” in FIG. 4) to minimize the hydrodynamic resistance of the main flow channel which lowers both the overall hydrodynamic resistance of the device and enables partitioning at high capillary number, e.g. Ca greater than 1. The cross section “b” of portion 410 of the main flow channel comprised of segments 411 and 412 can range from 22.5 um to 60 um.

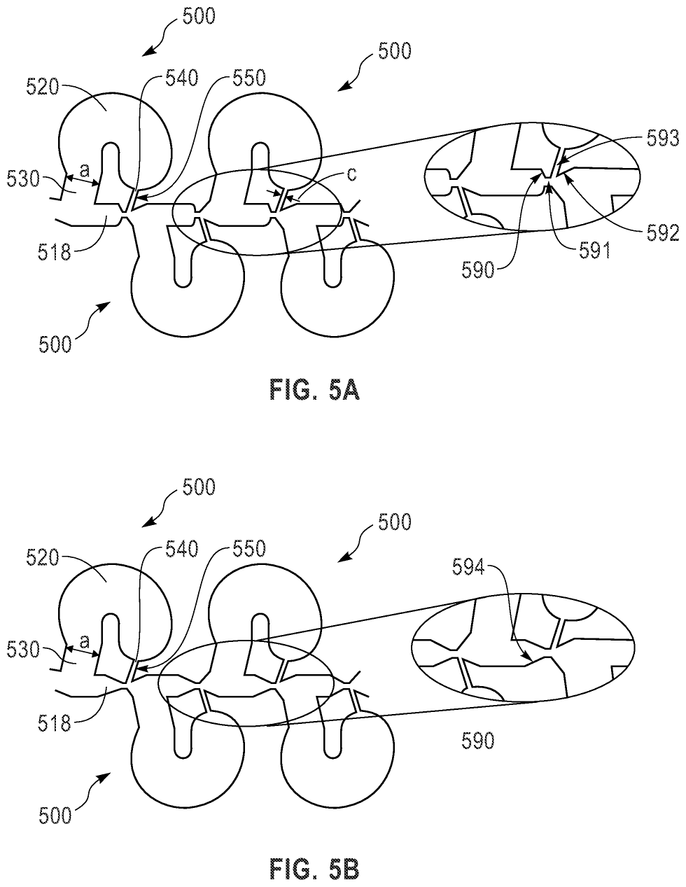

FIGS. 5A and 5B depict other embodiments of the microfluidic device 500 of the disclosure having a single capillary channel at the outlet chamber. Multiple devices 500 are depicted as arranged in series. Each device 500 comprises partition chamber 520 and each outlet chamber comprises one capillary channel 550; in the practice shown, capillary channel is configured as an elongated neck. In the practice shown and based upon FIG. 6, each outlet chamber capillary channel 550 has a cross section (“c”) of 12.5 μm; and each chamber inlet 530 has a cross section (“a”) of 100 μm. In the practice shown, the portion 510 of the main flow channel comprises two segments each of which have a cross section of 60 μm and connected by a neck down capillary channel 591 having a cross section of 20 μm to further restrict the width of the main flow channel. As opposed to FIG. 4, in the practice shown in FIGS. 5A, 5B, the outlet capillary channel 550 is not connected to portion 510 at point between adjacent neck down capillary channels 591, but instead is connected adjacent the neck down capillary channel 591. Thus outlet capillary channel 550 discharges next to the neck down capillary channel 591 at point 593. In another variation, the outlet capillary channel 550 discharges directly into neck down capillary channel 591. The configurations of FIGS. 5A, 5B facilitate control of unpinning, which if unduly uncontrolled at the neck down 591 and outlet capillary channel 550 can cause failure during the filling step. By linking the neck down to or adjacent the outlet capillary channel unpinning will occur at the same time at each location. Moreover, use of a smooth gradual transition 592 out of neck down capillary channel 591 and/or use of a smooth gradual transition 594 going into the neck down, as opposed to sharper transition 590, further avoids uncontrolled unpinning or burst flow.

A plurality of microfluidic devices disclosed herein can be arranged in series and/or in parallel to comprise a digital array as known in the art. Such arrangements allow for the generation of a large number of partition chambers. In one embodiment, the number of partition chambers is about 10,000 to about 20,000. In addition, the volume of the partition chambers depends solely on the design of the chambers and thus a design can comprise a range of partition chambers having different volumes in order to increase the dynamic range of the detection. The actuation used for partitioning can be done with a pressure driven syringe pump, centrifugal forces, and gravitational forces, thereby alleviating the need for specialized instrumentation. Moreover, the device can be read on a fluorescent scanner after the amplification step. For digital quantification the amplification can be performed using PCR or other type of molecular amplification such as isothermal LAMP for instance.

In addition to digital PCR application, other applications can be derived and based from the self-partitioning. The partition chambers can also be pre-printed with a specific primer to detect sequences specific to certain species such as pathogens. In this instance, a parallel series of partition chambers can be printed with specific primers such that parallel channels would test for the presence of different pathogens or strains of pathogens. Such a configuration would allow multiplex detection identification of pathogens and avoid cross-contamination of the amplification reactions by design. Also a similar device where partition chambers are pre-printed with barcodes could be used in conjunction with barcoding reaction to perform sample preparation for haplotyping or phased sequencing. In this configuration, each partition chamber would receive a large piece of genomic DNA that will be fragmented into smaller pieces compatible with high-throughput sequencing technologies and each barcoded with the same sequence, such that their sequences can be easily assembled into a single long contiguous sequence.

The microfluidic device can be fabricated by means known in the art. For example, by preparing a 5:1 wt. PDMS (commercially available as Sylgard 184, Dow Corning) embossing die which die was obtained by molding from a 10:1 wt. PDMS negative obtained by soft lithography. COC thermoplastic (commercially available as Topas 5013L-10, T_{g}=134° C.) can be embossed with the die in an oven set at 160° C. overnight. The device is sealed with a Pressure-Sensitive Adhesive (PSA)/film (commercially available as ThermaSeal RTS, Thomas Scientific) that was applied manually with a sealing paddle. The aqueous phase and immiscible fluids can be actuated with custom pressure controllers and off-chip reservoirs. The immiscible oil formulation (commercially available HFE 7500, from 3M) can have 1% wt. dissolved PEG-PFPE-PEG. Images can be collected using either a brightfield inverted microscope (Nikon Diaphot) equipped with a 4× objective and a digital camera (Sony XCVD-70) or a Nikon D5200 reflex mounted with a macro lens.

1. A microfluidic device comprising:
a main flow channel; and
a partitioning chamber connected to a section of the main flow channel by a chamber inlet and a chamber outlet, the chamber inlet comprising a chamber inlet cross section, the chamber outlet comprising one or more outlet capillary channels,
wherein a portion of the main flow channel between the chamber inlet and the chamber outlet comprises a cross section (i) less than the chamber inlet cross section, and (ii) greater than the cross section of each individual outlet capillary channel.

2. The device of claim 1 wherein the chamber outlet comprises more than one capillary channel.

3. The device of claim 2 wherein the capillary channels are parallel to each other.

4. The device of claim 3 wherein the capillary channels are formed by one or more elements protruding into the bypass outlet.

5. The device of claim 4 wherein the one or more elements protruding into the chamber outlet are each independently of rectangular cross section.

6. The device of claim 1 wherein the chamber outlet comprises one capillary channel.

7. The device of claim 6 wherein the chamber outlet comprising the one capillary channel is configured as an elongated neck.

8. The device of claim 1 wherein the chamber inlet comprises a cross section of between 50 μm and 250 μm; the one or more capillary channels each independently comprise a cross section of between 7.5 μm and 20 μm; and the cross section of the portion of the main flow channel between the chamber inlet and the chamber is between 15 μm and 30 μm.

9. The device of claim 1 wherein the cross section of the portion of the main flow channel between the chamber inlet and the chamber outlet is (i) constant along the length of the portion, or (ii) varies along the length of the portion.

10. The device of claim 9 wherein in (ii) the portion of the main flow channel between the chamber inlet and the chamber outlet is comprised of at least two segments wherein each segment has a different cross section.

11. The device of claim 10 wherein the segments are connected to each other by a respective segment capillary channel wherein each the respective segment capillary channel has a cross section less than the cross section of each segment.

12. The device of claim 10 wherein the chamber outlet comprises one capillary channel configured as an elongated neck connected to a segment.

13. The device of claim 11 wherein the chamber outlet comprises one capillary channel configured as an elongated neck connected to one respective segment capillary channel.

14. The device of claim 1 wherein the material of construction for the device comprises a thermoplastic that is non-permeable to gas.

15. The device of claim 14 wherein the thermoplastic comprises a Cyclic Olefin Copolymer (COC).

16. A digital array comprising a microfluidic device according to claim 1.

17. The digital array of claim 16 comprising a plurality of microfluidic devices, wherein at least a portion of the plurality of microfluidic devices are connected in series or in parallel.

18. A method of loading a biological sample for analysis into a microfluidic device, the method comprising:
(a) providing a microfluidic device comprising:
a main flow channel; and
a partitioning chamber connected to a section of the main flow channel by a chamber inlet and a chamber outlet, the chamber inlet comprising a chamber inlet cross section, the chamber outlet comprising one or more outlet capillary channels,
wherein a portion of the main flow channel between the chamber inlet and the chamber outlet comprises a cross section (i) less than the chamber inlet cross section, and (ii) greater than the cross section of each individual outlet capillary channel;
(b) providing a flow of a fluid comprising a biological sample in the main flow channel under conditions effective to divert a portion of the fluid from the main flow channel to the partitioning chamber and the chamber outlet;
(c) ceasing the flow of the fluid comprising the biological sample; and
(d) providing a flow of an immiscible fluid in the main flow channel under conditions effective to flow the immiscible fluid through the main channel and not into the chamber inlet or the chamber outlet to seal off the partitioning chamber and any fluid comprising the biological sample contained therein.

19. The method of claim 18 wherein providing the flow of the fluid comprising the biological sample in step (b) is under conditions effective wherein the capillary force associated with the flow is greater than the viscous force associated with the flow.

20. The method of claim 18 wherein in step (d) the flow of the immiscible fluid in the main channel is provided in the direction of the chamber inlet to the chamber outlet and is under conditions effective such that the viscous force associated with the flow of the immiscible fluid is greater than the capillary force associated with the flow of the immiscible fluid.

21. The method of claim 18 wherein in step (d) the flow of the immiscible fluid in the main channel is provided in the direction of the chamber outlet to the chamber inlet and is under conditions effective such that the capillary force associated with the flow of the immiscible fluid is greater than the viscous force associated with the flow of the immiscible fluid.

22. The method of claim 18 wherein the fluid comprising the biological sample is aqueous and the biological sample comprises one or more of the following: a cell, a virus, a protein, a nucleic acid, or portions of any of the foregoing.

23. The method of claim 18 wherein the immiscible fluid comprises an immiscible oil.

24. The method of claim 23 wherein the immiscible oil is fluorinated.

25. The method of claim 23 wherein the immiscible oil comprises a surfactant.

26. A method of analyzing a biological sample comprising:
(a) loading a biological sample for analysis into a microfluidic device according to the method of claim 18; comprising:
(b) performing an analysis on the biological sample contained in the partitioning chamber, wherein the analysis is quantitative, qualitative, or both.

27. The method of claim 26 wherein the analysis comprises performing a molecular reaction on the biological sample.

28. The method of claim 27 wherein the analysis comprises an amplification reaction, a detection reaction, or both.

29. The method of claim 28 wherein the analysis comprises any one or more of the following: a polymerase chain reaction (PCR), isothermal amplification, a LAMP assay, fluorescence detection, and luminescence detection.

30. The method of claim 26 wherein the analysis comprises determining the concentration of the biological sample.
